(19) United States
(12) Patent Application Publication
(10) Pub. No.: US 2022/0061336 A1
(43) Pub. Date: Mar. 3, 2022

(54) Natural Concentrated Composition for Killing and Repelling Pests

(71) Applicant: Rodney Sicalo, Marengo, IL (US)

(72) Inventor: Rodney Sicalo, Marengo, IL (US)

(21) Appl. No.: 17/412,189

(22) Filed: Aug. 25, 2021

Related U.S. Application Data
(60) Provisional application No. 63/070,176, filed on Aug. 25, 2020.

(51) Int. Cl. A01N 65/22; A01N 65/24; A01N 65/18; A01N 25/04

(52) U.S. Cl. CPC A01N 65/22; A01N 25/04; A01N 65/18; A01N 65/24

(57) ABSTRACT

A natural concentrated composition for killing and repelling pests is a dispensable composition that may effectively repels or kills pests based on the concentration. The dispensable composition includes a quantity of peppermint essential oil, a quantity of cedarwood essential oil, a quantity of cinnamon essential oil, a quantity of lemongrass essential oil, a quantity of castor oil, a quantity of rosemary essential oil, a quantity of thyme essential oil, and a quantity of garlic essential oil. The quantity of peppermint essential oil, the quantity of cedarwood essential oil, the quantity of cinnamon essential oil, the quantity of lemongrass essential oil, the quantity of castor oil, the quantity of rosemary essential oil, the quantity of thyme essential oil, and the quantity of garlic essential oil are homogeneously mixed into the dispensable composition for an effective pest exterminator and repellent. The dispensable composition may be mixed with at least one supplemental ingredient.

The current application claims a priority to the U.S. Provisional Patent application Ser. No. 63/070,176 filed on Aug. 25, 2020.

### FIELD OF THE INVENTION

The present invention generally relates to a natural concentrated composition for killing and repelling pests. More specifically, the present invention provides an insecticide and/or an insect repellent.

### BACKGROUND OF THE INVENTION

Existing compositions for facilitating destroying of organisms is deficient with regard to several aspects. For instance, most current compositions do not include plant-derived natural ingredients. Furthermore, current compositions do not include biodegradable ingredients. Further, current compositions that use natural ingredients are not 100% biodegradable. Further, current compositions may include harsh synthetic chemicals that are harmful to the environment and people.

Therefore, there is a need for improved material composition for facilitating destroying of organisms that may overcome one or more of the above-mentioned problems and/or limitations.

### BRIEF DESCRIPTION OF THE DRAWINGS

FIG. 1 is a block diagram showing a dispensable composition.

FIG. 2 is a block diagram showing the dispensable composition with at least one composition-enhancing ingredient.

FIG. 3 is a block diagram showing a plurality of composition-enhancing ingredients.

FIG. 4 is a block diagram showing a first embodiment of a diluted solution.

FIG. 5 is a block diagram showing a second embodiment of the diluted solution.

FIG. 6 is a block diagram showing the diluted solution with at least one solution-enhancing ingredient.

FIG. 7 is an illustration showing a plurality of solution-enhancing ingredients.

FIG. 8 is an illustration showing the front of a container retaining the dispensable composition.

FIG. 9 is an illustration showing the back of the container retaining the dispensable composition.

FIG. 10 is an illustration showing an embodiment of a spray device retaining the diluted solution.

FIG. 11 is an illustration showing another embodiment of the spray device retaining the diluted solution.

FIG. 12 is an illustration showing another embodiment of the spray device retaining the diluted solution.

### DETAIL DESCRIPTIONS OF THE INVENTION

All illustrations of the drawings are for the purpose of describing selected versions of the present invention and are not intended to limit the scope of the present invention.

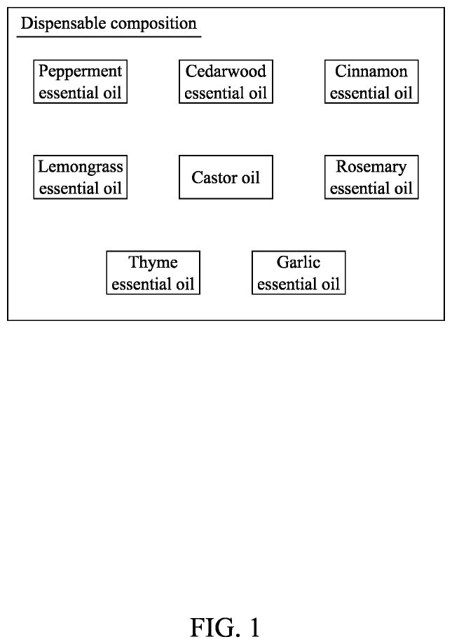

The present invention is a natural concentrated composition for killing and repelling pests. More specifically, the present invention is used to kill wasps, hornets, and other insects. The present invention may also repel other bugs and rodents. The present invention utilizes natural ingredients that are safe both indoors and outdoors around children and pets. The present invention may be configured for destroying, eliminating, controlling, or repelling various organisms based on the contact with each organism. The present invention does not have any residual killing properties and only kills insects that are directly sprayed with the present invention. Moreover, the present invention may be Environmental Protection Agency (EPA) exempt as it is a minimum risk pest control solution under the Federal Insecticide, Fungicides, and Rodenticide (FIFRA) act. Furthermore, the present invention is 100% biodegradable and may reduce environmental pollution. The present invention may comprise a quantity of peppermint essential oil, a quantity of cedarwood essential oil, a quantity of cinnamon essential oil, a quantity of lemongrass essential oil, a quantity of castor oil, a quantity of rosemary essential oil, a quantity of thyme essential oil, and a quantity of garlic essential oil, which is shown in FIG. 1. The quantity of peppermint essential oil, the quantity of cedarwood essential oil, the quantity of cinnamon essential oil, the quantity of lemongrass essential oil, the quantity of castor oil, the quantity of rosemary essential oil, the quantity of thyme essential oil, and the quantity of garlic essential oil are compositional components that aid in the killing and/or repelling of insects. Moreover, the quantity of peppermint essential oil, the quantity of cedarwood essential oil, the quantity of cinnamon essential oil, the quantity of lemongrass essential oil, the quantity of castor oil, the quantity of rosemary essential oil, the quantity of thyme essential oil, and the quantity of garlic essential oil are homogeneously mixed in a dispensable composition so that the present invention can be readily and effectively deployed as a pest exterminator and/or repellent.

In order to optimize the potency of the present invention, the aforementioned compositional components are mixed at specific preferred ratios. Thus, the quantity of peppermint essential oil is approximately 7.5 percentage by volume (vol. %) of the dispensable composition at normal temperature and pressure (NTP). Furthermore, the quantity of cedarwood essential oil is approximately 5 vol. % of the dispensable composition at NTP. Furthermore, the quantity of cinnamon essential oil is approximately 5 vol. % of the dispensable composition at NTP. Furthermore, the quantity of lemongrass essential oil is approximately 5 vol. % of the dispensable composition at NTP. Furthermore, the quantity of castor oil is approximately 5 vol. % of the dispensable composition at NTP. Furthermore, the quantity of rosemary essential oil is approximately 2.5 vol. % of the dispensable composition at NTP. Furthermore, the quantity of thyme essential oil is approximately 2.5 vol. % of the dispensable composition at NTP. Furthermore, the quantity of garlic essential oil is approximately 0.47 vol. % of the dispensable composition at NTP.

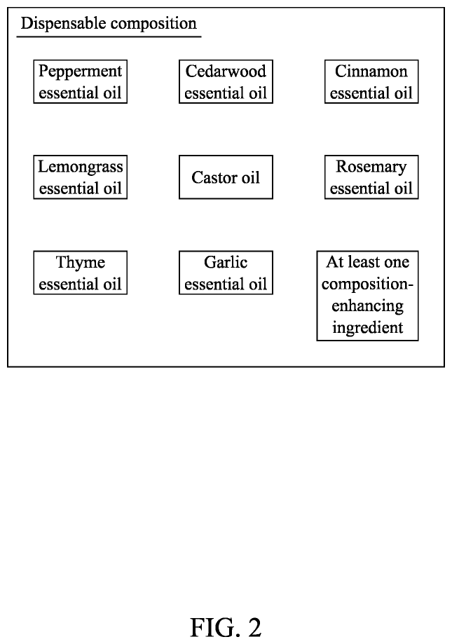

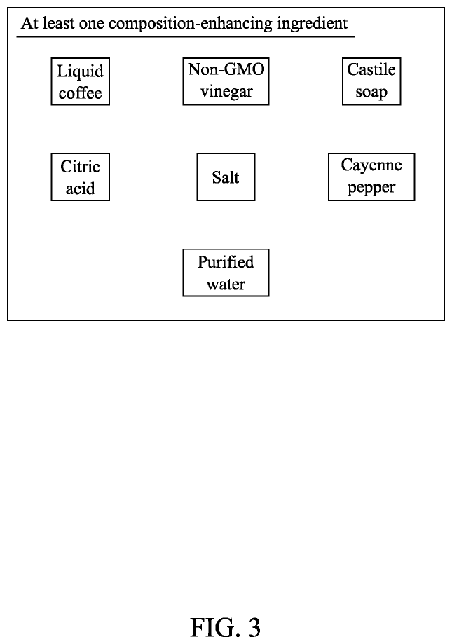

As can be seen in FIG. 2, the present invention may further comprise at least one composition-enhancing ingredient, which is also used to optimize the potency of the present invention. Thus, the at least one composition-enhancing ingredient is further heterogeneously mixed into the dispensable composition. Moreover, the at least one composition-enhancing ingredient can be a quantity of liquid coffee (i.e., preferably organic), a quantity of non-genetically-modified-organism (non-GMO) vinegar, a quantity of castile soap (i.e., preferably organic), a quantity of citric acid, a quantity of salt (i.e., preferably sea salt), a quantity of cayenne pepper, a quantity of purified water (i.e., highly filtered water), or combinations thereof, which is shown in FIG. 3. In addition, each kind of composition-enhancing ingredient is a minimum risk-inert ingredient that aids in the targeting of a specific type of pest. The quantity of liquid coffee can be used as a repellant for garden insects. The quantity of non-GMO vinegar can be used to kill and repel insects. The quantity of castile soap can be used to kill insects and acts as an oil emulsifier. More specifically, the quantity of castile soap is used to target soft bodied insects. In some embodiments of the present invention, the at least one supplemental ingredient comprises the quantity of castile soap, and the quantity of castile soap is approximately between 30 to 40 vol. % of the dispensable composition at NTP. The quantity of citric acid and the quantity of salt can be used to kill insects and act as preservatives for the dispensable composition. The quantity of cayenne pepper can be used as a natural repellant and aids to specifically kill aphids on plants. The quantity of purified water can be used to fluidize the dispensable composition.

The at least one supplemental ingredient is preferably filtered with hot water and vinegar several times into the dispensable composition. Each time that the at least one supplemental ingredient is filtered, the dispensable composition becomes increasingly concentrated. In some embodiments of the present invention, the at least one supplemental ingredient is filtered 2 to 3 times until the dispensable composition is noticeable strong.

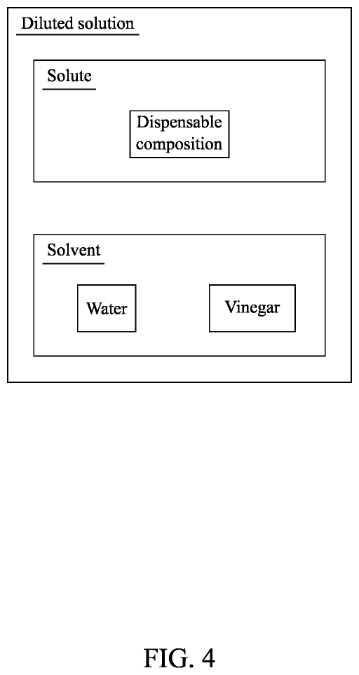

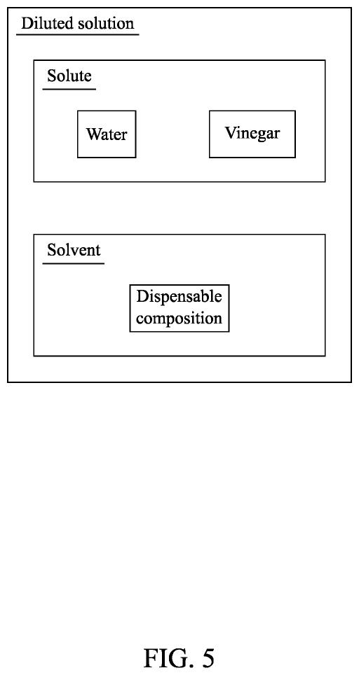

The concentration of the dispensable composition may be selectively reduced into a diluted solution, which is configured to achieve a desired effect in killing or repelling pest. The diluted solution comprises two compositional components, which are a quantity of solute and a quantity of solvent. In a first embodiment of the present invention shown in FIG. 4, the quantity of solute is the dispensable composition, and the quantity of solvent can be a quantity of water, a quantity of vinegar, or combinations thereof. The first embodiment of the present invention allows for a weaker concentration of the dispensable composition that is configured to address a mild pest-control problem. For example, the first embodiment can be used to only repel a pest, to kill smaller or minor pests (e.g., mosquitos), to be applied indoors (i.e., typically where pets and people are present), or to treat plants while not harming the plants. Moreover, the quantity of solvent is preferably equal parts of the quantity of water and the quantity of vinegar in the first embodiment. In a second embodiment of the present invention shown in FIG. 5, the quantity of solute can be a quantity of water, a quantity of vinegar, or combinations thereof, and the quantity of solvent is the dispensable composition. The second embodiment of the present invention allows for a stronger concentration of the dispensable composition that is configured to address a severe pest-control problem. For example, the second embodiment can be used to repel both insects and rodents and be used to kill fleas and ticks around the exterior and interior of a home, providing up to 4 weeks of control. Moreover, the quantity of solute is preferably equal parts of the quantity of water and the quantity of vinegar in the second embodiment. In addition, a commonality between the first embodiment and the second embodiment is that the quantity of vinegar aids in killing both insects (e.g., gnats and mosquitoes) and arachnids (e.g., spiders and scorpions).

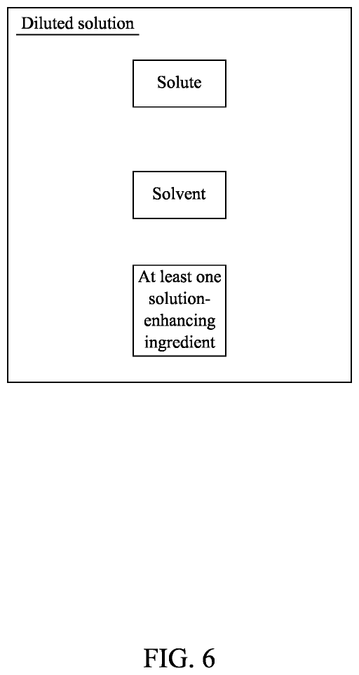

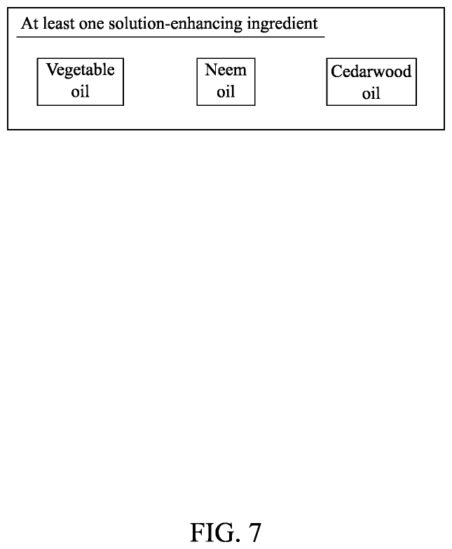

As can be seen in FIG. 6, the present invention may further comprise at least one solution-enhancing ingredient, which is used to optimize the potency of the diluted solution. Thus, the at least one solution-enhancing ingredient is further heterogeneously mixed into the dispensable composition. Moreover, the at least one solution-enhancing ingredient can be a quantity of vegetable oil, a quantity of Neem oil, a quantity of cedarwood oil, of combinations thereof, which is shown in FIG. 7. The quantity of vegetable oil allows the diluted solution to remain longer on plant leaves. Furthermore, as the quantity of vegetable oil decomposes quickly, a fresh batch of the dispensable composition may be mixed every few months. The quantity of Neem oil aids to kill pests in gardens. The quantity of cedarwood oil targets mosquitos and the like.

Some exemplary embodiments for proportions of the present invention include the following:
1 to 2 spoons of vegetable oil are mixed with the dispensable solution to serve as an emulsifier. Then, a quantity of water, preferably warm and approximately 1 gallon, is added and the shook before applying the dispensable solution to a plant.
A dose of the dispensable composition is 0.8 fluid ounces with 2 doses diluted into 32 ounces of water, which is used to kill wasps, ants, and other insects in 15 to 90 seconds.
A dose of the dispensable composition is 0.8 fluid ounces with 1.5 doses diluted into 32 ounces of water, which is used to kill wasps, ants, and other insects in 1 to 3 minutes.
A dose of the dispensable composition is 0.8 fluid ounces with 1 dose diluted into 32 ounces of water, which is used to kill wasps, ants, and other insects in 3 to 5 minutes.
A dose of the dispensable composition is 0.8 fluid ounces with approximately 4 to 6 doses diluted into 32 ounces of water, which is used to repel rodents with varying sizes.
A dose of the dispensable composition is 0.8 fluid ounces with 1 dose diluted into approximately 2 to 8 ounces of a combination of water and vinegar, which is meant for a small area of treatment such as a garage.
A dose of the dispensable composition is 0.8 fluid ounces with approximately 4 to 16 doses diluted into 1 gallon of water, which is meant for small areas but larger amounts of batches.
A dose of the dispensable composition is 0.8 fluid ounces with approximately 2 to 3 doses diluted into 32 ounces of water, which is used to kill spiders and cockroaches.
A dose of the dispensable composition is 0.8 fluid ounces with 1 dose diluted into 1 gallon of water, which is used for gardening areas.
A dose of the dispensable composition is 0.8 fluid ounces with approximately 2 to 4 doses diluted into 16 ounces of water or a combination of water and vinegar, which is used to kill household insects and insects on plants yet does not kill the plants themselves.
A dose of the dispensable composition is 0.8 fluid ounces with approximately 1 to 2 doses diluted into 32 ounces of water, which is used to kill wasps, hornets, ants, yellow jackets, crickets, and other similar insects.

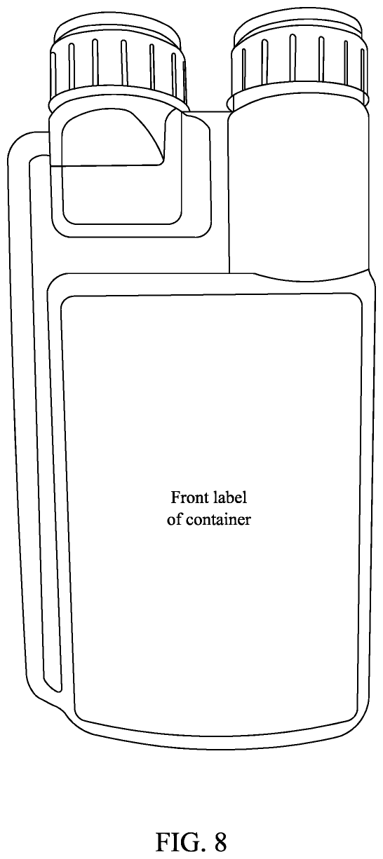

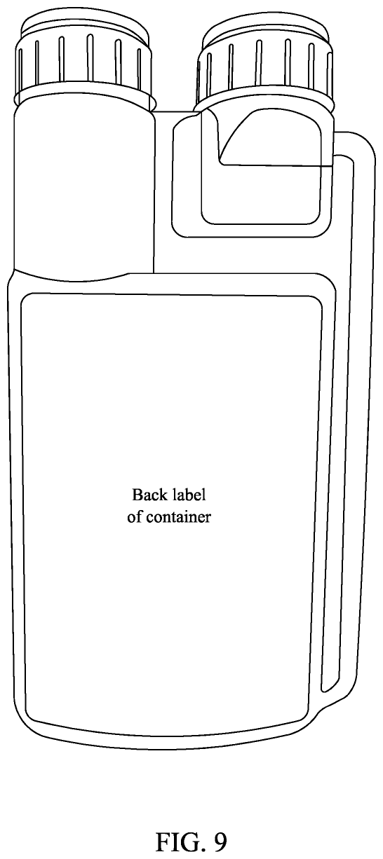

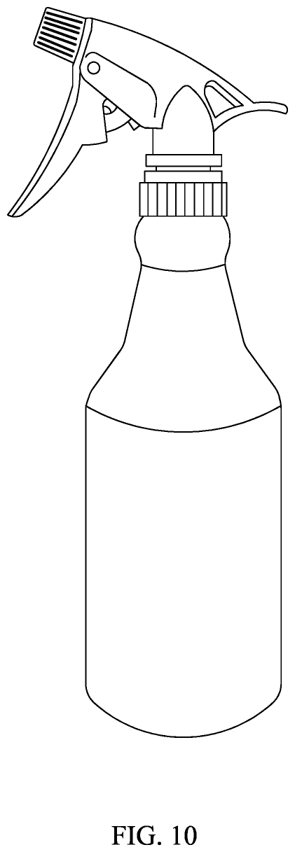

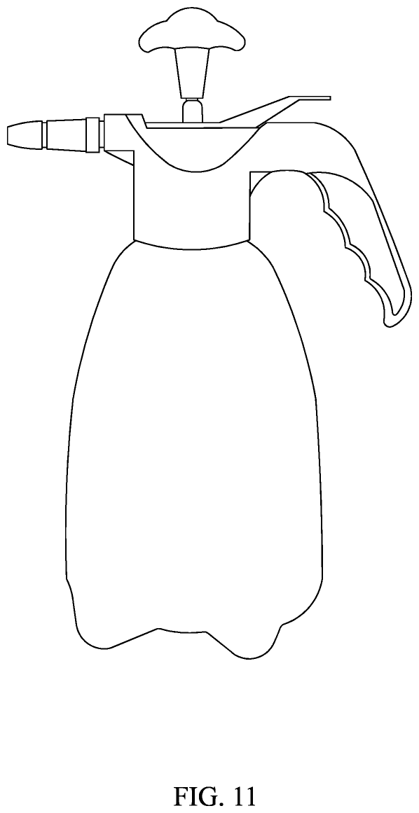

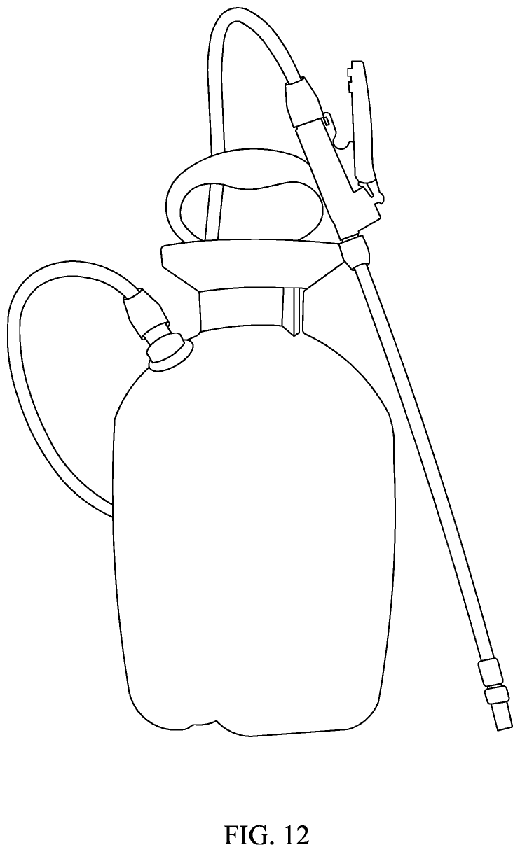

The dispensable composition may be retained within a container (FIGS. 8 and 9), such as a dosing bottle, and may be applied with a spray device (FIGS. 10 through 12). In order to properly apply the present invention, the container is shaken before opening. A dosing cap of the container is removed, and a seal is separated from an opening of the container. The at least one concentration-enhancing ingredient, the quantity of water, the quantity of vinegar, the at least one solution-enhancing ingredient, or combinations thereof are selected and mixed into the container in order to produce a final diluted solution. The final diluted solution is then poured into the spray device. The final diluted solution is then applied to the desired pest or area. Repeated applications of the final diluted solution may be necessary depending on the type of pest. It is recommended to exterminate a pest at dusk or night if the pest if a wasp or hornet as wasps and hornets are typically less aggressive at that time.

Although the invention has been explained in relation to its preferred embodiment, it is to be understood that many other possible modifications and variations can be made without departing from the spirit and scope of the invention as hereinafter claimed.

What is claimed is:

1. A natural concentrated composition for killing and repelling pests comprising:
a quantity of peppermint essential oil;
a quantity of cedarwood essential oil;
a quantity of cinnamon essential oil;
a quantity of lemongrass essential oil;
a quantity of castor oil;
a quantity of rosemary essential oil;
a quantity of thyme essential oil;
a quantity of garlic essential oil; and,
the quantity of peppermint essential oil, the quantity of cedarwood essential oil, the quantity of cinnamon essential oil, the quantity of lemongrass essential oil, the quantity of castor oil, the quantity of rosemary essential oil, the quantity of thyme essential oil, and the quantity of garlic essential oil being homogeneously mixed in a dispensable composition.

2. The natural concentrated composition for killing and repelling pests as claimed in claim 1, wherein the quantity of peppermint essential oil is approximately 7.5 percentage by volume (vol. %) of the dispensable composition at normal temperature and pressure (NTP).

3. The natural concentrated composition for killing and repelling pests as claimed in claim 1, wherein the quantity of cedarwood essential oil is approximately 5 vol. % of the dispensable composition at NTP.

4. The natural concentrated composition for killing and repelling pests as claimed in claim 1, wherein the quantity of cinnamon essential oil is approximately 5 vol. % of the dispensable composition at NTP.

5. The natural concentrated composition for killing and repelling pests as claimed in claim 1, wherein the quantity of lemongrass essential oil is approximately 5 vol. % of the dispensable composition at NTP.

6. The natural concentrated composition for killing and repelling pests as claimed in claim 1, wherein the quantity of castor oil is approximately 5 vol. % of the dispensable composition at NTP.

7. The natural concentrated composition for killing and repelling pests as claimed in claim 1, wherein the quantity of rosemary essential oil is approximately 2.5 vol. % of the dispensable composition at NTP.

8. The natural concentrated composition for killing and repelling pests as claimed in claim 1, wherein the quantity of thyme essential oil is approximately 2.5 vol. % of the dispensable composition at NTP.

9. The natural concentrated composition for killing and repelling pests as claimed in claim 1, wherein the quantity of garlic essential oil is approximately 0.47 vol. % of the dispensable composition at NTP.

10. The natural concentrated composition for killing and repelling pests as claimed in claim 1, wherein at least one composition-enhancing ingredient is further heterogeneously mixed into the dispensable composition, and wherein the at least one composition-enhancing ingredient is selected from a group consisting of: a quantity of liquid coffee, a quantity of non-genetically-modified-organism (non-GMO) vinegar, a quantity of castile soap, a quantity of citric acid, a quantity of salt, a quantity of cayenne pepper, a quantity of purified water, and combinations thereof.

11. The natural concentrated composition for killing and repelling pests as claimed in claim 10, wherein the at least one supplemental ingredient comprises the quantity of castile soap, and wherein the at least one the quantity of castile soap is approximately between 30 to 40 vol. % of the dispensable composition at NTP.

12. The natural concentrated composition for killing and repelling pests as claimed in claim 1, wherein a diluted solution comprises a quantity of solute and a quantity of solvent, and wherein the quantity of solute is the dispensable composition, and the quantity of solvent is selected from a group consisting of: a quantity of water, a quantity of vinegar, and combinations thereof.

13. The natural concentrated composition for killing and repelling pests as claimed in claim 12, wherein at least one solution-enhancing ingredient is further heterogeneously mixed into the diluted solution, and wherein the at least one solution-enhancing ingredient is selected from a group consisting of: a quantity of vegetable oil, a quantity of Neem oil, a quantity of cedarwood oil, and combinations thereof.

14. The natural concentrated composition for killing and repelling pests as claimed in claim 1, wherein a diluted solution comprises a quantity of solute and a quantity of solvent, and wherein the quantity of solute is selected from a group consisting of: a quantity of water, a quantity of vinegar, and combinations thereof, and the quantity of solvent is the dispensable composition.

15. The natural concentrated composition for killing and repelling pests as claimed in claim 14, wherein at least one solution-enhancing ingredient is further heterogeneously mixed into the dispensable composition, and wherein the at least one solution-enhancing ingredient is selected from a group consisting of: a quantity of vegetable oil, a quantity of Neem oil, a quantity of cedarwood oil, and combinations thereof.
